(19) United States
(12) Patent Application Publication
(10) Pub. No.: US 2010/0039435 A1
(43) Pub. Date: Feb. 18, 2010

(54) DISPLAY CAPABLE OF BEING CONNECTED TO INTERNET

(75) Inventor: Tzu-Pang Chiang, Taoyuan County (TW)

Correspondence Address: COVENANT IP CONSULTING CO., P.O. BOX 34-306 TAIPEI CITY, TAIPEI, 10499, TW

(73) Assignee: BENQ CORPORATION, Taipei City (TW)

(21) Appl. No.: 12/541,178

(22) Filed: Aug. 14, 2009

(30) Foreign Application Priority Data
Aug. 14, 2008 (TW) 97131026

(51) Int. Cl. G06F 13/14

(52) U.S. Cl. 345/520

(57) ABSTRACT

A display includes a screen, a mouse input port to be coupled to a mouse, a mouse output port to be coupled to a computer mouse port, a storage unit storing an Internet web browser program, a video input port for receiving a video output signal from a computer, and a microprocessor electrically coupled to the storage unit and the video input port. The microprocessor detects whether the video input port receives the video output signal. If yes, the display operates in a first mode, the microprocessor executes the Internet web browser program, and the screen displays a web page accessed by the Internet web browser program. If not, the display operates in a second mode and the microprocessor makes the mouse input port to the mouse output port, so that the mouse is electrically coupled to the computer mouse port and the screen displays the video output signal.

This application claims the benefit of Taiwan application Serial No. 97131026, filed Aug. 14, 2008, the subject matter of which is incorporated herein by reference.

### BACKGROUND OF THE INVENTION

1. Field of the Invention

The invention relates in general to a display selectively coupled to the Internet, and more particularly to a display selectively coupled to the Internet without being externally coupled to a computer.

2. Description of the Related Art

FIG. 1 (Prior Art) is a schematic illustration showing a conventional display 10 used with a personal computer 12. As shown in FIG. 1, the conventional display 10 only has a video input port for receiving and displaying a video output signal of the personal computer 12. The conventional display 10 does not have the computing ability for independently executing the program or being coupled to the Internet. So, the display 10 has to be used with the personal computer 12, such as a desktop computer or a notebook computer.

The personal computer 12 can typically execute an Internet web browser program 20, such as the Internet Explorer or Firefox, under the Microsoft Windows or Linux operating system. Also, the personal computer 12 has connecting ports to be coupled to a mouse 14, a keyboard 16 and a network cable 18. The user can execute the Internet web browser program 20 by operating the mouse 14 and the keyboard 16. The personal computer 12 outputs the video signal containing the frames corresponding to the Internet web browser program 20 and web page to the display 10 so that the display 10 displays the frames corresponding to the web pages and the Internet web browser program 20.

Thus, no matter the user wants to browse the web pages by using a CPU (central processing unit) of low computing ability and a memory of low capacity, or the user wants to execute the complicated programs, such as Access, Excel and Word by using a CPU of high computing ability and a memory of high capacity, it is necessary for the user to buy a computer.

### SUMMARY OF THE INVENTION

The invention is directed to a display selectively coupled to the Internet, and more particularly to a display selectively coupled to the Internet without being externally coupled to a computer.

According to the present invention, a display is provided. The display includes a screen, a man-machine interface input port coupled to a man-machine interface, a man-machine interface output port selectively coupled to a man-machine interface port of a computer, a storage unit storing an Internet web browser program, a video input port selectively coupled to a video output port of the computer for receiving a video output signal from the computer, and a microprocessor electrically coupled to the storage unit and the video input port. The microprocessor detects whether the video input port receives the video output signal.

When the user only wants to browse web pages on the Internet, he or she needs not to turn on the personal computer but only needs to turn on the display. At this time, no video output signal is presented at the video input port, the display operates in a first mode, and the microprocessor of the display executes the Internet web browser program so that the screen displays the web page accessed by the Internet web browser program, and the man-machine interface input port is isolated from the man-machine interface output port of the computer.

Oppositely, when the user wants to execute the complicated program, such as Access or Excel, the user may turn on the personal computer. Thus, the video output signal is received at the video input port, the display operates in a second mode, the microprocessor of the display makes the man-machine interface input port coupled to the man-machine interface output port, so that the man-machine interface device is electrically coupled to the man-machine interface port of the computer and the screen can display the video output signal received from the computer.

When the user only wants to browse the web pages on the Internet, he or she needs not to execute the Internet web browser program in the personal computer so that the power consumption of the personal computer can be greatly reduced, the computer virus on the Internet can be isolated from the personal computer, or the personal computer can only pay attention to the execution of other application programs, such as the program of writing the optical disk, or the program of scanning the computer virus on the hard drive.

The invention will become apparent from the following detailed description of the preferred but non-limiting embodiments. The following description is made with reference to the accompanying drawings.

### BRIEF DESCRIPTION OF THE DRAWINGS

FIG. 1 (Prior Art) is a schematic illustration showing a conventional display used with a personal computer.

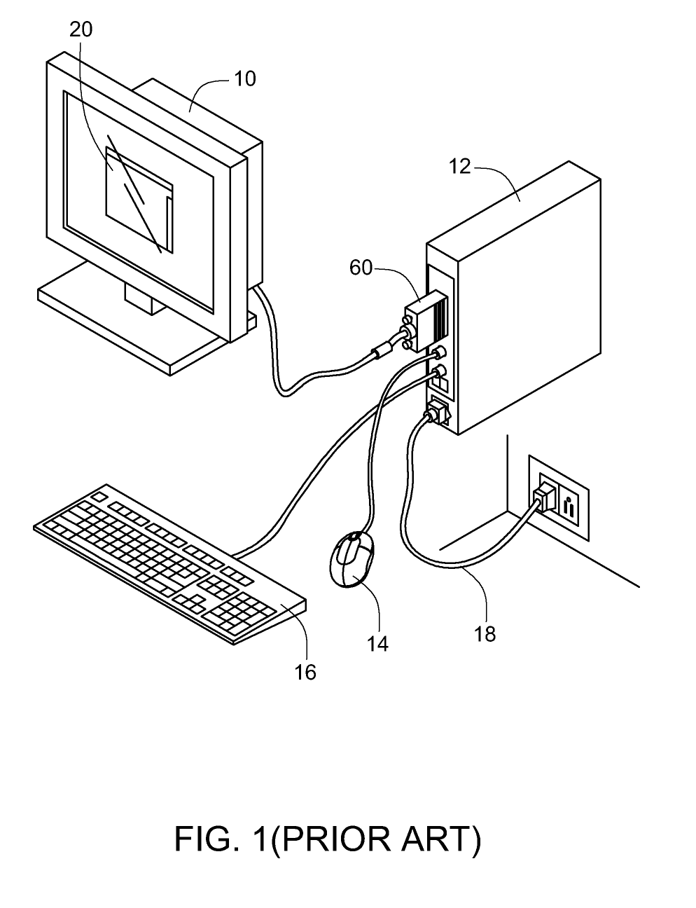

FIG. 2 shows a display according to a preferred embodiment of the invention.

FIG. 3 is a block diagram of a display according to a first embodiment of the invention when a computer is shut down or when a video output signal of the computer does not exist.

FIG. 4 is a block diagram of the display according to the first embodiment of the invention when the computer is powered on or when the video output signal of the computer exist.

FIG. 5 is a flow chart showing the operation of the display performed in response to whether the video output signal of the personal computer exists.

FIG. 6 is a block diagram showing a display when a computer is shut down or a video output signal of the computer does not exist according to a second embodiment of the invention.

FIG. 7 is a block diagram showing the display when the computer is powered on or the video output signal of the computer exists according to the second embodiment of the invention.

### DETAILED DESCRIPTION OF THE INVENTION

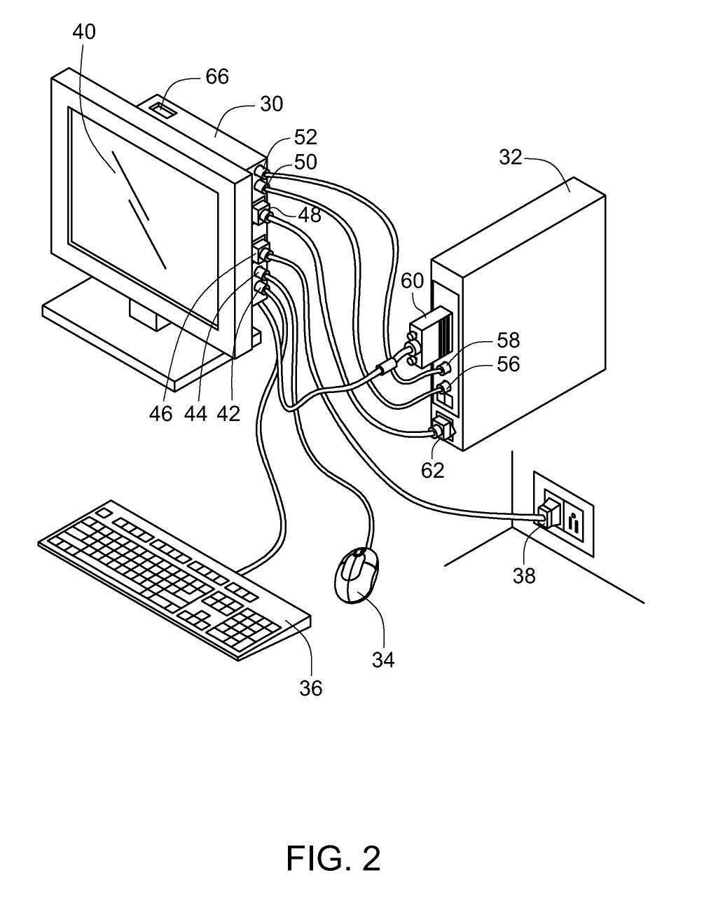

FIG. 2 shows a display 30 according to a preferred embodiment of the invention. As shown in FIG. 2, the display 30 can be coupled to a personal computer 32.

A screen 40, a keyboard input port 42, a mouse input port 44, a network input port 46, a network output port 48, a keyboard output port 50, a mouse output port 52, a video input port 54 (not shown in FIG. 2) and a universal serial bus (USB) port 66 are disposed on a housing of the display 30. The keyboard input port 42 and the mouse input port 44 are examples of man-machine interface input port, and the keyboard output port 50 and the mouse output port 52 are examples of man-machine interface output port.

The keyboard input port 42 can be coupled to a keyboard 36, the mouse input port 44 can be coupled to a mouse 34, the keyboard output port 50 can be coupled to a keyboard port 56 of the computer 32, the mouse output port 52 can be coupled to a mouse port 58 of the computer 32, the network input port 46 can be coupled to a network signal source 38, the network output port 48 can be coupled to a network port 62 of the computer 32. The video input port 54 can be coupled to a video output port 60 of the computer 32 for receiving a video output signal from the computer 32.

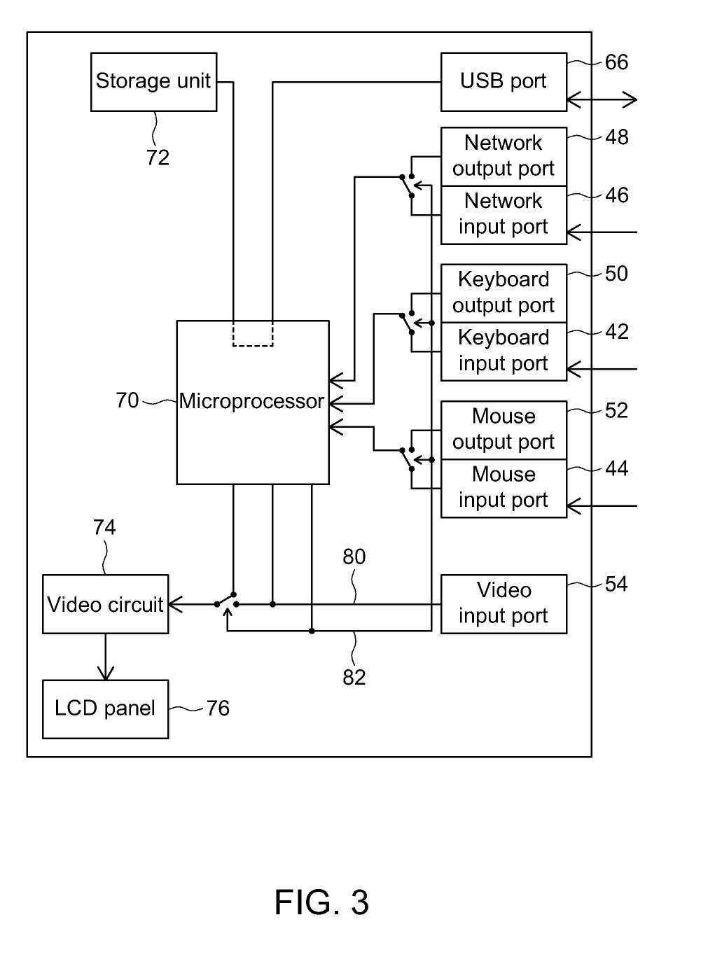

FIG. 3 is a block diagram of the display 30 according to a first embodiment of the invention when the computer is shut down or when the video output signal of the computer does not exist. Referring to FIG. 3, the display 30 includes a storage unit 72, a microprocessor 70, a video circuit 74 and a liquid crystal display (LCD) panel 76.

The storage unit 72 may includes into a system file storing section and a user file storing section. The system file storing section can store an operating system, for example the simplified Linux operating system, and the simplified FireFox Internet web browser program, while the user file storing section can store web pages and files downloaded when the user is browsing the web pages.

The microprocessor 70 is electrically coupled to the storage unit 72, the video circuit 74 and the video input port 54. As indicated by the path 82

the microprocessor 70 continuously detects whether the video input port 54 receives the video output signal outputted from the computer 32.

As shown in FIG. 3, when the display 30 is powered on and no video output signal is presented at the video input port 54, the display 30 operates in a first mode under the control of the path 82. Through the path 82, the microprocessor 70 controls four switches (e.g., 1-to-2 de-multiplexers) to electrically connect the microprocessor 70 to the keyboard input port 42, the mouse input port 44, the network input port 46 and the video circuit 74 selectively. The microprocessor 70 can receive the instructions generated when the user operates the keyboard 36 and the mouse 34 through the keyboard input port 42 and the mouse input port 44, and thus execute the operating system and the Internet web browser program. The microprocessor 70 displays frames corresponding to the operation of operating system and the Internet web browser program on the screen 40 through the video circuit 74. The keyboard input port 42 and the mouse input port 44 are isolated from the keyboard 56 and the mouse port 58 of the computer 32 respectively. The keyboard 56 and the mouse port 58 are examples of man-machine interface output ports of the computer 32.

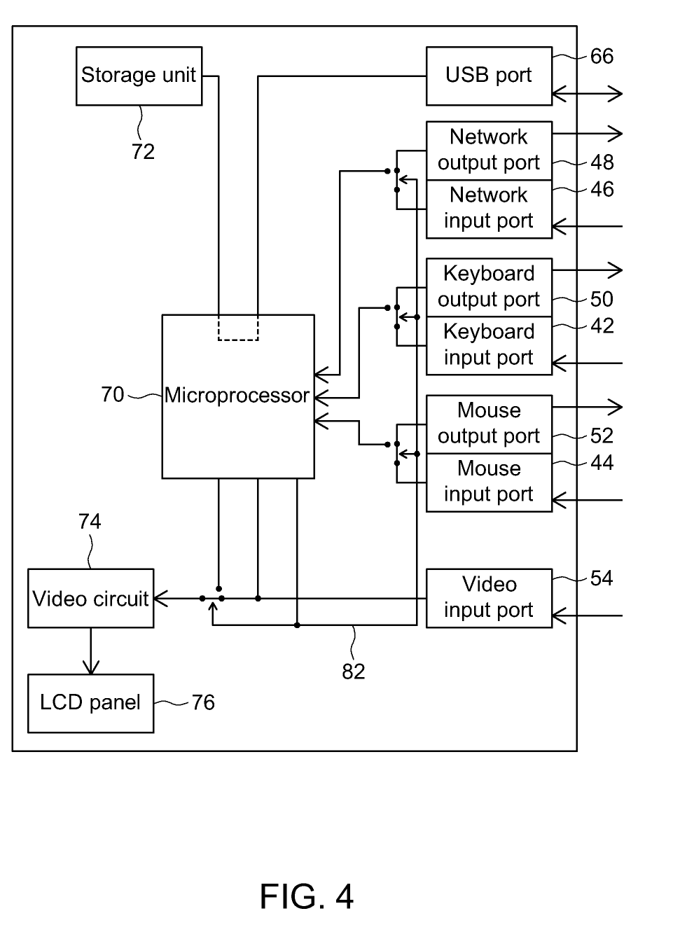

As shown in FIG. 4, when the display 30 is powered on and the video output signal is received at the video input port 54, the display 30 operates in a second mode under the control of the path 82. Through the path 82, the microprocessor 70 controls four switches to electrically connect the keyboard output port 50 to the keyboard input port 42, to electrically connect the mouse output port 52 to the mouse input port 44, to electrically connect the network output port 48 to the network input port 46, and to electrically connect the video input port 54 to the video circuit 74. Consequently, the mouse 34, the keyboard 36 and the network signal source 38 are respectively coupled to the mouse port 58, the keyboard port 56 and the network port 62, and the video circuit 74 processes the video output signal and thus displays the frames received from the computer 32 on the screen 40. Thus, the display 30 can be used as a conventionally display by the user in this mode, and the display 30 only provides the function of displaying the frames from the computer 32.

As shown in FIG. 3, when the display 30 is in the first mode, the microprocessor 70 executes the operating system, and the user file storing section can store the web pages and the user files downloaded when the user is browsing the web pages by the operating system.

Referring to FIG. 4, the display 30 further includes a data access port, for example USB port 66, satisfying a USB mass storage unit class (USB MSC) standard, and the USB port 66 is electrically coupled to the user file storing section. When the display 30 is in the second mode and the USB port 66 is coupled to the computer 32, the user may access the user file stored in the user file storing section through the computer 32. More particularly, the USB port can be coupled to the USB port of the computer 32. If the computer 32 executes the Microsoft Window operating system (Microsoft Windows OS), the user file storing section can become a removable storage unit under the Microsoft Window OS of the computer 32.

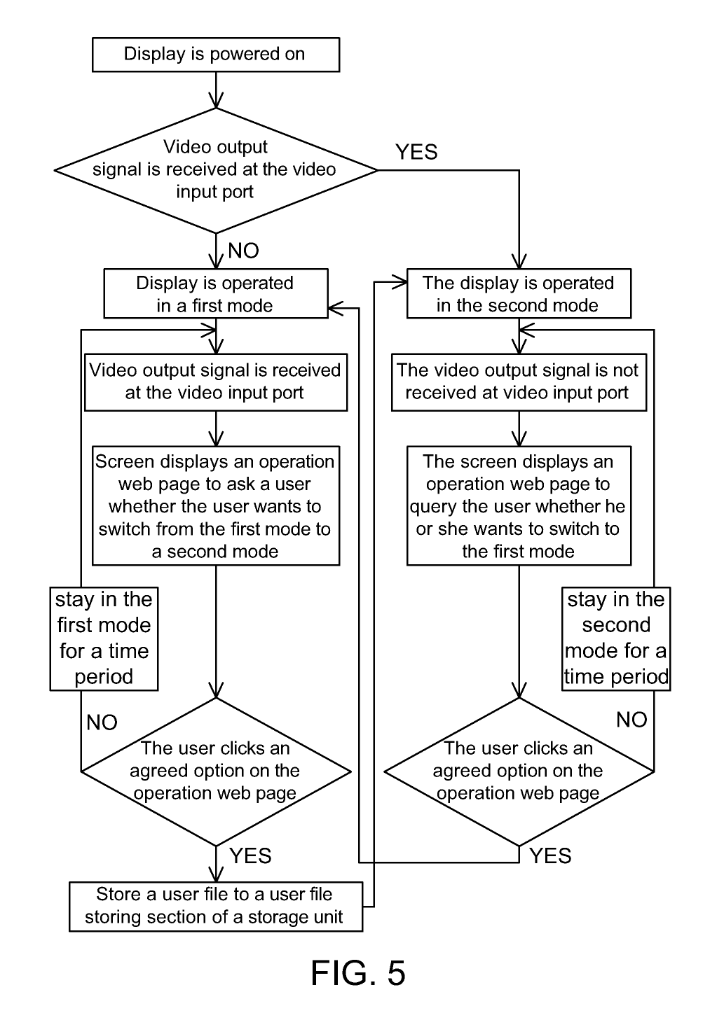

As shown in the left half portion of the flow chart of FIG. 5, when the display 30 has completely powered on and is initially operated in the first mode, and the video output signal is later received at the video input port, the microprocessor 70 displays a message on the screen 40 to ask the user whether he or she wants to switch from the first mode to the second mode. If a personal file has not yet been stored after the user clicks the agreed option on the screen 40, the display 30 firstly stores the personal file to the user file storing section of the storage unit 72, and then the display 30 is switched to the second mode in response to the user's selection.

As shown in the right half portion of the flow chart of FIG. 5, when the display 30 has completely powered on and is initially operated in the second mode, and the video output signal is not received at the video input port 54, the microprocessor 70 displays a message on the screen 40 to ask the user whether the user wants to switch from the second mode to the first mode. The display 30 is selectively switched to the first mode in response to the user's selection.

The keyboard input port 42 and the mouse input port 44 may utilize (i) the mouse and keyboard connector and circuit interface of the personal computer with the IBM PS/2 standard, or (ii) the connector and circuit interface with the USB standard. The keyboard output port 50 and the mouse output port 52 preferably adopt the same interface of either (i) the IBM PS/2 standard or (ii) the USB standard with the keyboard input port 42 and the mouse input port 44.

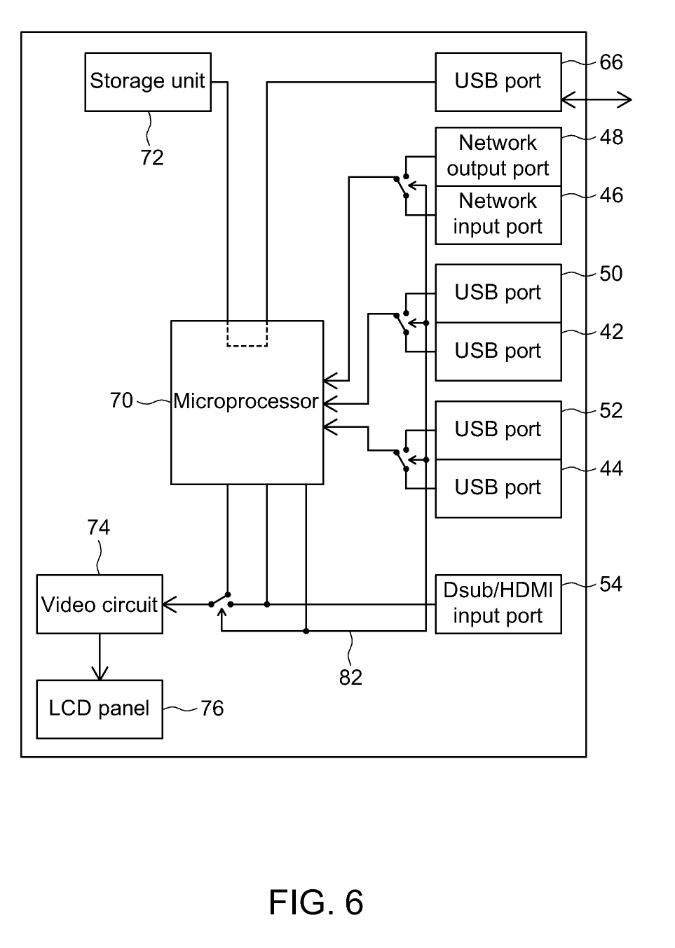

As shown in FIG. 6, if the keyboard input port 42 and the mouse input port 44 adopt the USB circuit interface and connector, the display 30 powers the external USB keyboard and the external USB mouse through the USB interfaces of the keyboard input port 42 and the mouse input port 44 when the display 30 is in the first mode.

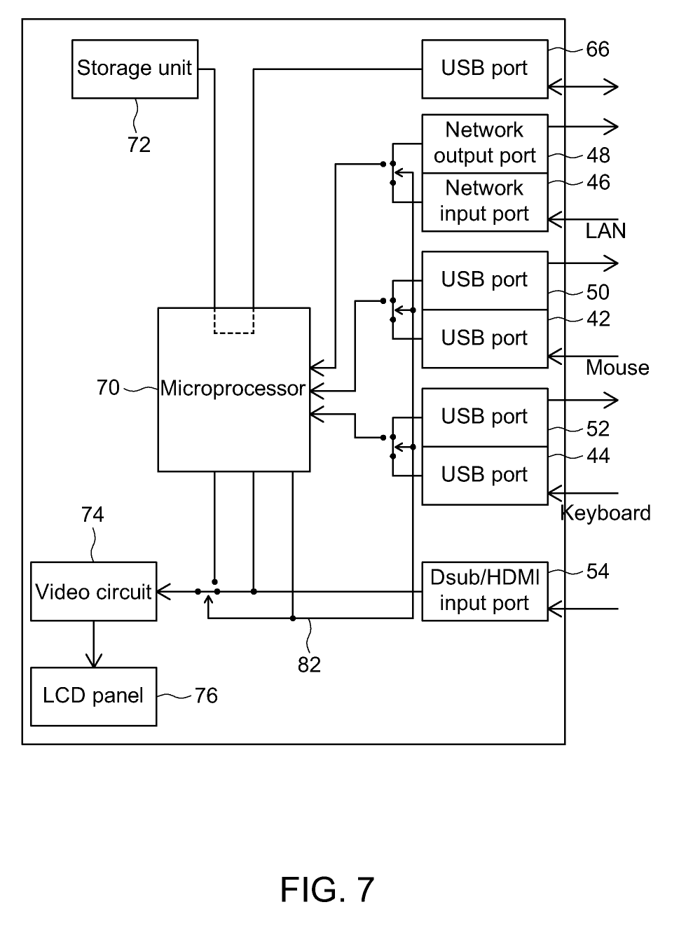

As shown in FIG. 7, if the keyboard input port 42 and the mouse input port 44 adopt the USB circuit interface and connector, the microprocessor 70 electrically connects the keyboard output port 50 to the keyboard input port 42, and the mouse output port 52 is electrically coupled to the mouse input port 44 when the display 30 is in the second mode. Thus, the USB port of the computer 32 can directly power the external USB keyboard and the external USB mouse.

While the invention has been described by way of examples and in terms of preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A display selectively coupled to a computer, the display comprising:
a screen;
a man-machine interface input port coupled to a man-machine interface device;
a man-machine interface output port selectively coupled to a man-machine interface port of the computer;
a storage unit storing an Internet web browser program;
a video input port, selectively coupled to a video output port of the computer for receiving a video output signal from the computer; and
a microprocessor, electrically coupled to the storage unit and the video input port, for detecting whether the video input port receives the video output signal;
wherein when the display is powered on and no video output signal is presented at the video input port, the display operates in a first mode, the microprocessor executes the Internet web browser program and the screen displays a web page accessed by the Internet web browser program, and the man-machine interface input port is isolated from the man-machine interface output port of the computer;
wherein when the display is powered on and the video output signal is received at the video input port, the display operates in a second mode, the microprocessor makes the man-machine interface input port coupled to the man-machine interface output port, so that the man-machine interface device is coupled to the man-machine interface port of the computer, and the microprocessor makes the screen to display the video output signal received from the computer.

2. The display according to claim 1, further comprising a network input port coupled to a network signal source, and a network output port selectively coupled to a network port of the computer;
wherein when the display is operated in the first mode, the microprocessor makes the network input port isolated from the network output port;
wherein when the display is operated in the second mode, the microprocessor makes the network input port coupled to the network output port, so that the network signal source is coupled to the network port of the computer.

3. The display according to claim 1, wherein:
the man-machine interface input port comprises a mouse input port coupled to a mouse, and the man-machine interface output port comprises a mouse output port selectively coupled to a mouse port of the computer;
wherein when the display is operated in the first mode, the microprocessor makes the mouse input port isolated from the mouse output port;
wherein when the display is operated in the second mode, the microprocessor makes the mouse input port coupled to the mouse output port so that the mouse is coupled to the mouse port of the computer.

4. The display according to claim 1, wherein:
the man-machine interface input port comprises a keyboard input port coupled to a keyboard, and the man-machine interface output port comprises a keyboard output port selectively coupled to a keyboard port of the computer;
wherein when the display is operated in the first mode, the microprocessor makes the keyboard input port isolated from the keyboard output port;
wherein when the display is operated in the second mode, the microprocessor makes the keyboard input port coupled to the keyboard output port, so that the keyboard is coupled to the keyboard port of the computer.

5. The display according to claim 1, wherein when the display is initially operated in the first mode, and the video output signal is later received at the video input port, the microprocessor displays a message on the screen to ask a user whether the user wants to switch from the first mode to the second mode, and the display is selectively switched to the second mode in response to the user's selection.

6. The display according to claim 1, wherein when the display is initially operated in the second mode, and the video output signal later disappeared at the video input port, the microprocessor displays a message on the screen to ask a user whether the user wants to switch from the second mode to the first mode, and the display is selectively switched to the first mode in response to the user's selection.

7. The display according to claim 1, wherein the storage unit further comprises an system file storing section and a user file storing section, an operating system is saved in the system file section, and when the display is operated in the first mode, the microprocessor executes the operating system, through which a user can access a user file stored in the user file storing section.

8. The display according to claim 1, wherein the storage unit further comprises a user file storing section, and the display further comprises a data access port coupled to the user file storing section;
wherein when the display is in the second mode and the data access port is coupled to the computer, the user can access a user file stored in the user file storing section through the computer.

9. The display according to claim 8, wherein the data access port has a universal serial bus mass storage unit class (USB MSC) circuit, the data access port coupled to a USB port of the computer executing an operating system, so that the user file storing section becomes a removable storage unit under the operating system of the computer.

10. The display according to claim 1, wherein:
the man-machine interface input port has a USB connector, the man-machine interface device is a USB device;
when the display is operated in the first mode, the microprocessor makes the man-machine interface input port supply power to the USB device;
when the display is operated in the second mode, the microprocessor makes the man-machine interface input port coupled to the man-machine interface output port of the computer, so the USB device receiving power supply from the computer.

11. A display control method for a display, the display having a screen, a man-machine interface input port coupled to a man-machine interface device, a man-machine interface output port coupled to a man-machine interface port of a computer, a storage unit for storing an Internet web browser program, a video input port coupled to a video output port of the computer for receiving a video output signal from the computer, and a microprocessor for detecting whether the video input port receives the video output signal, the method comprising the steps of:
enabling the display to enter a first mode, enabling the microprocessor to execute the Internet web browser program, and enabling the screen to display a web page accessed by the Internet web browser program when the display is powered on and if the video input port has not received the video output signal; and
enabling the display to enter a second mode, enabling the microprocessor to make the man-machine interface input port electrically coupled to the man-machine interface output port so that the man-machine interface device is coupled to the man-machine interface port, and enabling the microprocessor to make the screen display the video output signal when the display is powered on and if the video input port receives the video output signal.

12. The method according to claim 11, further comprising the step of:
enabling the microprocessor to display a message on the screen to query a user whether the user wants to switch to the second mode when the display is in the first mode and the video input port receives the video output signal later, wherein the display is switched to the second mode if the user clicks an agreed option on the screen.

13. The method according to claim 12, further comprising the step of:
enabling the display to firstly store a personal file to the storage unit and then to switch to the second mode if the personal file has not yet been stored.

14. The method according to claim 11, further comprising the step of:
enabling the microprocessor to display a message on the screen to query a user whether the user wants to switch to the first mode when the display is in the second mode and the video output signal disappears later, wherein the display is switched to the first mode if the user clicks an agreed option on the screen.

15. A system, comprising:
a computer; and
a display coupled to the computer, the display comprising:
a screen;
a man-machine interface input port coupled to a man-machine interface device;
a man-machine interface output port coupled to a man-machine interface port of the computer;
a storage unit storing an Internet web browser program;
a video input port, coupled to a video output port of the computer for receiving a video output signal from the computer; and
a microprocessor, electrically coupled to the storage unit and the video input port, for detecting whether the video input port receives the video output signal;
wherein when the display is powered on and no video output signal is presented at the video input port, the display operates in a first mode, the microprocessor executes the Internet web browser program and the screen displays a web page accessed by the Internet web browser program, and the man-machine interface input port is isolated from the man-machine interface output port of the computer;
wherein when the display is powered on and the video output signal is received at the video input port, the display operates in a second mode, the microprocessor makes the man-machine interface input port coupled to the man-machine interface output port, so that the man-machine interface device is coupled to the man-machine interface port of the computer, and the microprocessor makes the screen to display the video output signal received from the computer.

16. The system according to claim 15, wherein the display further comprising a network input port coupled to a network signal source, and a network output port coupled to a network port of the computer;
wherein when the display is operated in the first mode, the microprocessor makes the network input port isolated from the network output port;
wherein when the display is operated in the second mode, the microprocessor makes the network input port coupled to the network output port, so that the network signal source is coupled to the network port of the computer.

17. The system according to claim 15, wherein:
the man-machine interface input port comprises a mouse input port coupled to a mouse, and the man-machine interface output port comprises a mouse output port coupled to a mouse port of the computer;
wherein when the display is operated in the first mode, the microprocessor makes the mouse input port isolated from the mouse output port;
wherein when the display is operated in the second mode, the microprocessor makes the mouse input port coupled to the mouse output port so that the mouse is coupled to the mouse port of the computer.

18. The system according to claim 15, wherein:
the man-machine interface input port comprises a keyboard input port coupled to a keyboard, and the man-machine interface output port comprises a keyboard output port coupled to a keyboard port of the computer;
wherein when the display is operated in the first mode, the microprocessor makes the keyboard input port isolated from the keyboard output port;
wherein when the display is operated in the second mode, the microprocessor makes the keyboard input port coupled to the keyboard output port, so that the keyboard is coupled to the keyboard port of the computer.

19. The system according to claim 15, wherein when the display is initially operated in the first mode, and the video output signal is later received at the video input port, the microprocessor displays a message on the screen to ask a user whether the user wants to switch from the first mode to the second mode, and the display is selectively switched to the second mode in response to the user's selection;
wherein when the display is initially operated in the second mode, and the video output signal later disappeared at the video input port, the microprocessor displays a message on the screen to ask a user whether the user wants to switch from the second mode to the first mode, and the display is selectively switched to the first mode in response to the user's selection.

20. The system according to claim 15, wherein the storage unit further comprises an system file storing section and a user file storing section, an operating system is saved in the system file section, and when the display is operated in the first mode, the microprocessor executes the operating system, through which a user can access a user file stored in the user file storing section.
